(19) United States
(12) Patent Application Publication
(10) Pub. No.: US 2016/0269737 A1
(43) Pub. Date: Sep. 15, 2016

(54) INTRA PREDICTION DEVICE AND INTRA PREDICTION METHOD

(71) Applicant: Panasonic Intellectual Property Management Co., Ltd., Osaka (JP)

(72) Inventors: Kazuma SAKAKIBARA, Osaka (JP); Kiyofumi ABE, Osaka (JP); Hideyuki OHGOSE, Osaka (JP); Koji ARIMURA, Osaka (JP); Hiroshi ARAKAWA, Tokyo (JP)

(21) Appl. No.: 15/062,818

(22) Filed: Mar. 7, 2016

(30) Foreign Application Priority Data
Mar. 9, 2015 (JP) 2015-046476
Jan. 21, 2016 (JP) 2016-009714

(51) Int. Cl. H04N 19/50; H04N 19/172; H04N 19/436; H04N 19/103

(52) U.S. Cl. CPC H04N 19/50; H04N 19/103; H04N 19/172; H04N 19/436

(57) ABSTRACT

An intra prediction unit is a device for performing intra predictions compliant with a specified picture coding standard, and comprises n prediction processing units that perform a parallel processing of the intra predictions, where n is an integer larger than one. Each of m prediction modes excluding at least, one prediction mode among a plurality of prediction modes defined in the specified picture coding standard is allocated to one of the n prediction processing units, where m is an integer larger than one. Each of the n prediction processing units performs an evaluation processing for the allocated one or more prediction modes to evaluate which prediction mode is to be selected among the m prediction modes.

### BACKGROUND

1. Technical Field

The present disclosure relates to an intra prediction device and an intra prediction method for performing infra predictions compliant with a specified picture coding standard.

2. Description of the Related Art

The H.264/MPEG-4 AVC scheme (hereafter referred to as the H.264 scheme) is known as a moving picture coding standard. In this moving picture coding standard, an intra prediction (infra-picture prediction) is carried out by selecting one of a plurality of intra prediction modes (see, for example, Unexamined Japanese Patent Publication No. 2014-27371).

Also, High Efficiency Video Coding (HEVC) has been under study as a next generation moving picture coding standard as a successor to the H. 264 scheme.

### SUMMARY

It has been desired for the intra prediction processing to increase the processing speed.

The present disclosure provides an intra prediction device or an intra prediction method that makes it possible to realize a high speed processing of intra prediction.

An intra prediction device in an aspect of the present disclosure is an intra prediction device for performing intra predictions compliant; with a specified picture coding standard, and comprises n prediction processing units that perform a parallel processing of the intra predictions, where n is an integer larger than one. Each of m prediction modes excluding at least one prediction mode among a plurality of prediction modes defined in the specified picture coding standard is allocated to one of the a prediction processing units, where m is an integer larger than one. Each of the n prediction processing units performs an evaluation processing for allocated one or more prediction modes to evaluate which prediction mode is to be selected among the in prediction modes.

An intra prediction device or an intra prediction method in accordance with the present disclosure makes it possible to realize a high speed processing of intra prediction.

### BRIEF DESCRIPTION OF DRAWINGS

FIG. 1 is a block diagram of a picture coding device in accordance with an exemplary embodiment;

FIG. 2 is a flowchart of a picture coding method in accordance with the exemplary embodiment;

FIG. 3 is a diagram illustrating pixel data used for an intra prediction in accordance with the exemplary embodiment;

FIG. 4 is a block diagram of an intra prediction unit (an intra-picture prediction device) in accordance with the exemplary embodiment;

FIG. 5 is a flowchart of an intra prediction in accordance with the exemplary embodiment;

FIG. 6 is a diagram illustrating intra prediction modes in accordance with the exemplary embodiment;

FIG. 7 is a diagram for explaining a planar prediction mode in accordance with the exemplary embodiment;

FIG. 8 is a diagram illustrating an example of allocating intra prediction modes in accordance with the exemplary embodiment;

FIG. 9 is another diagram illustrating an example of allocating intra prediction modes in accordance with the exemplary embodiment;

FIG. 10 is a diagram for explaining allocation of intra prediction modes in accordance with the exemplary embodiment;

FIG. 11 is a diagram illustrating an example of allocating intra prediction modes in accordance with the exemplary embodiment; and

FIG. 12 is a diagram illustrating another example of allocating intra prediction modes in accordance with the exemplary embodiment.

### DETAILED DESCRIPTION

Hereinafter, an exemplary embodiment will be described with reference to the accompanying drawings as appropriate. However, unnecessarily detailed description may occasionally be omitted. For example, detailed description of well-known matters and redundant description of substantially the same configuration may occasionally be omitted. This is to avoid the following description from becoming unnecessarily redundant, and to allow any person skilled in the art to easily understand the description.

Also, the inventors intend to provide the following description and the accompanying drawings so that any person skilled in the art can fully understand the present disclosure, and do not intend to limit the subject matter described in the appended claims by the following description and the accompanying drawings.

### Exemplary Embodiment

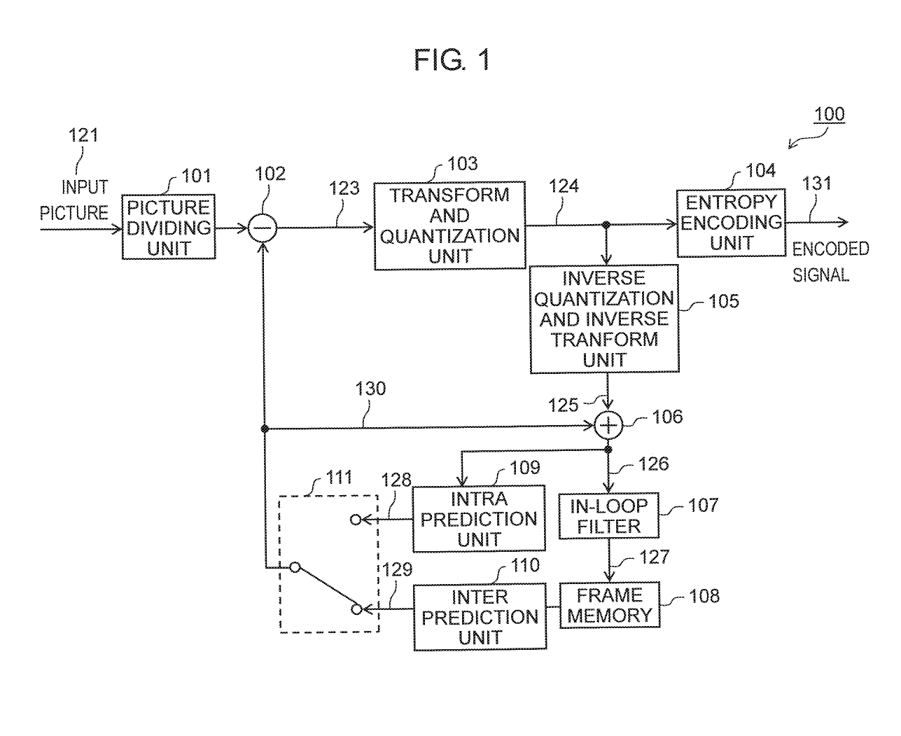

Hereinafter, an exemplary embodiment will be described with reference to FIG. 1 to FIG. 12. Although operations in a case of performing a picture coding processing operation compliant with the HEVC standard will be described for the purpose of explanation, it should be noted that the present exemplary embodiment is applicable to picture coding processing operations compliant with some other picture coding standards.

### Entire Processing in Picture Coding Device

FIG. 1 is a block diagram of picture coding device 100 in accordance with an exemplary embodiment.

Picture coding device 100 performs compression-coding of input picture 121 based on the HEVC standard to produce coded signal 131.

Picture coding device 100 shown in FIG. 1 comprises picture dividing unit 101, subtracting unit 102, transform and quantization unit 103, entropy coding unit 104, inverse quantization and inverse transform unit 105, adding unit 106, in-loop filter 107, frame memory 108, intra prediction unit 109, inter prediction unit 110, and switching unit 111.

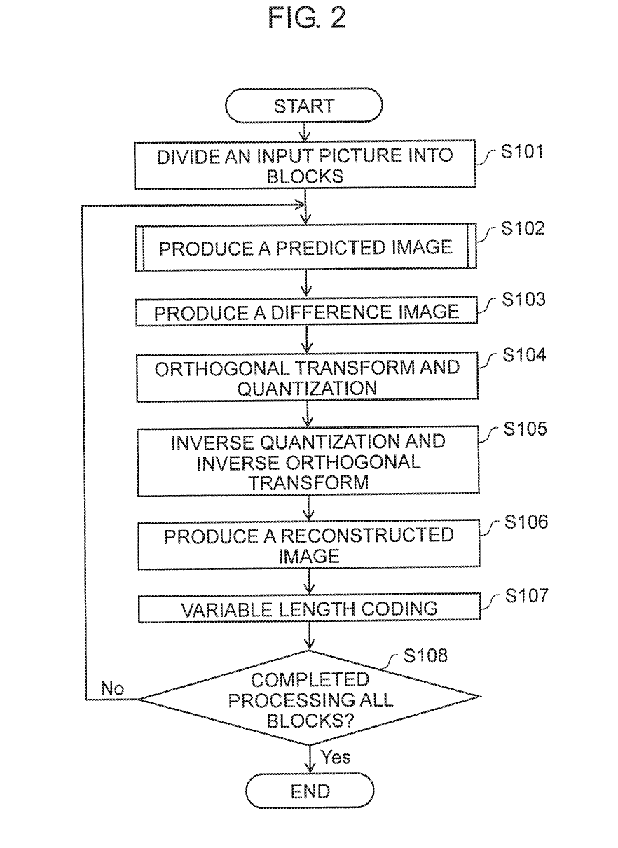

FIG. 2 is a flowchart of a picture coding processing performed by picture coding device 100.

First, picture dividing unit 101 divides an object picture to be encoded., included in input picture 121, into a plurality of coding unit blocks (coding units CUs), and divides each of the plurality of divided coding units into a plurality of blocks each being a unit of intra prediction (prediction units PUs) (S101). Each processing part included in picture coding device 100 performs processing of data in the unit of CU, PU, TU (TU will be described later) or an aggregation of these. The size of each CU, PU or TU may be determined using information calculated from the object picture to be encoded, such, for example, as image features, or may be determined using a prediction by an intra prediction unit or an inter prediction unit which will be described later, or may be determined by any criteria at any timing.

Next, each of intra prediction unit 109 and inter prediction unit 110 produces predicted image 130 (S102). Specifically, intra prediction unit 109 produces predicted image 128 by using an intra prediction based on reconstructed image 126. Intra prediction unit 109 produces predicted image 128 in the unit of PU.

Inter prediction unit 110 performs an inter prediction using reconstructed image 127 stored in frame memory 108 to produce predicted image 129. More specifically, inter prediction unit 110 estimates from the reconstructed image 127 a region that has a most similar pixel structure to the pixel structure of input picture 121 (motion estimation), and produces the retrieved region in reconstructed image 127 as predicted image 129 (motion compensation). Inter prediction unit 110 performs this processing in the unit of PU.

Switching unit 111 selects one predicted image 130 which is estimated to be higher in coding efficiency from predicted image 128 produced by intra prediction unit 109 and predicted image 129 produced by inter prediction unit 110. Specifically, for example, switching unit 111 selects, from the intra prediction and the inter prediction, one prediction method which provides a minimum sum of the amount of information required for encoding prediction errors and the amount of side information such as motion vectors or the like.

Next, subtracting unit 102 calculates a difference between at least one CU output from picture dividing unit 101 as an object to be processed and predicted image 130 output from intra prediction unit 109 or inter prediction unit 110 to produce difference image 123 (S103).

Transform and quantization unit 103 performs orthogonal transform of difference image 123 to produce orthogonal transform coefficients. Transform and quantization unit 103 performs orthogonal transform of difference image 123 in the unit of a sub-block for orthogonal transform. The sub-block for orthogonal transform is called a transform unit (TU). Transform and quantization unit 103 then quantizes each of frequency components of the obtained orthogonal transform coefficients to produce quantized coefficients 124 (S104).

Inverse quantization and inverse transform unit 105 performs an inverse quantization and an inverse orthogonal transform of quantized coefficients 124 to reconstruct difference image 125 (S105).

Adding unit 106 adds difference image 125 and predicted image 130 to produce reconstructed image 126 (S106).

In-loop filter 107 performs an in-loop filtering such, for example, as de-blocking filtering of reconstructed image 12(3. Frame memory 108 stores reconstructed image 127 after having been subjected to the in-loop filtering.

On the other hand, entropy coding unit 104 performs a variable length coding of quantized coefficients 124 to produce encoded signal 131 (S107).

The above-described processes are performed sequentially with respect to all blocks contained in the object picture to be encoded (S108).

### Intra Prediction

Next, an intra prediction performed by intra prediction unit 109 will be described in detail. Intra prediction unit 109 corresponds to an intra prediction device in accordance with the present disclosure.

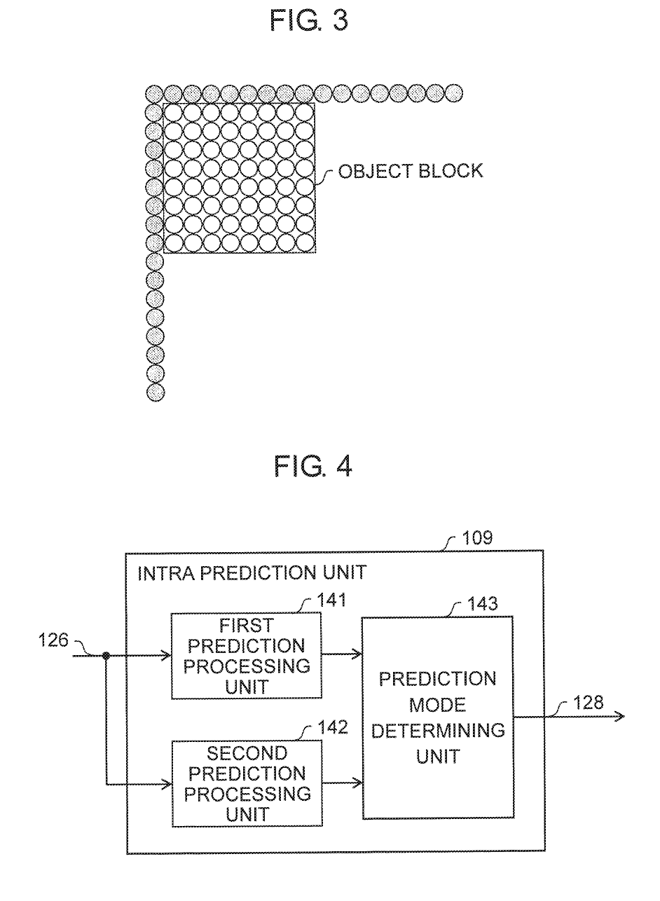

Intra prediction unit 109 produces predicted image 128 of an object block by using pixel data which are contained in previously coded blocks (reconstructed image 126) and located around the object block. Specifically, as shown in FIG. 3, intra prediction unit 109 performs intra prediction using pixel data contained in the lower left, left, upper left, upper and upper right blocks (the pixel data indicated by hatching in FIG. 3).

FIG. 4 is a block diagram of intra prediction unit 109. Intra prediction unit 109 comprises first prediction processing unit 141, second prediction processing unit 142, and prediction mode determining unit 143.

In the present exemplary embodiment, the use of a part of prediction modes is limited among 35 intra prediction modes defined in the HEVC standard, which is a picture coding standard assumed in picture coding device 100. In other words, intra prediction unit 109 selects one prediction mode from m prediction modes (m is an integer larger than 1) excluding at least one prediction mode among the 35 prediction modes defined in the HEVC standard. Intra prediction unit 109 performs intra prediction based on the selected intra prediction mode to produce predicted image 128.

Further, in the present exemplary embodiment, a parallel processing of intra predictions is performed by first prediction processing unit 141 and second prediction processing unit 142. Specifically, each of the m prediction modes is allocated to either first prediction processing unit 141 or second prediction processing unit 142. Each of first prediction processing unit 141 and second prediction processing unit 142 performs an evaluation processing for the allocated one or more prediction modes to evaluate which prediction mode is to be selected among the in prediction modes. Here, the evaluation processing is specifically a processing for calculating a cost value of each prediction mode. The cost value is an index indicating an encoding efficiency. Specifically, for example, the cost value may be a difference between input picture 121 and predicted image 128. It may be guessed that a smaller difference shows a smaller cost value, or a higher encoding efficiency. A prediction mode corresponding to a minimum cost value is determined as an intra prediction mode to be used.

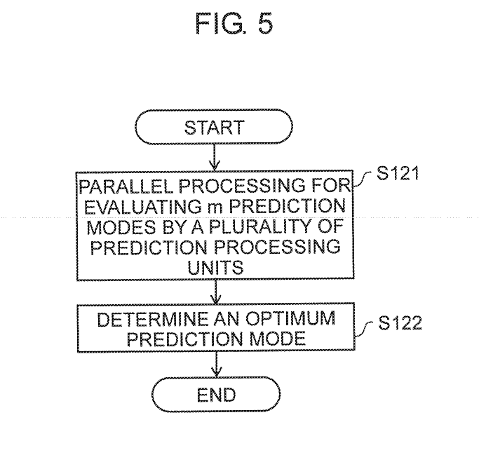

FIG. 5 is a flowchart of an intra prediction performed by intra prediction unit 109. First, first prediction processing unit 141 and second prediction processing unit 142 perform evaluation processing operations for the m prediction modes in parallel (S121). Specifically, a cost value of each of the m prediction modes is calculated. Each of first prediction processing unit 141 and second, prediction processing unit 142 is typically configured by a dedicated circuit (hardware). However, each of first prediction processing unit 141 and second prediction processing unit 142 may be implemented by such processors that are individually provided to execute programs.

Next, intra prediction unit 109 determines, as an intra prediction mode to be used, an intra prediction mode that provides a minimum cost value among the obtained cost values (S122). Specifically, each of first prediction processing unit 141 and second prediction processing unit 142 notifies prediction mode determining unit 143 of a minimum cost value among cost values calculated by itself and a prediction mode corresponding to the minimum cost value. Prediction mode determining unit 143 determines, as an intra prediction mode to be used, one that provides a smaller cost value of the prediction modes notified from first prediction processing unit 141 and second prediction processing unit 142.

Incidentally, it may be configured such that first prediction processing unit 141 and second prediction processing unit 142 notify prediction mode determining unit 143 of all cost values of the m prediction modes, and that prediction mode determining unit 143 selects a prediction mode which provides a minimum cost value among the in prediction modes.

### Allocation of Prediction Modes

Next, description will be made on allocation of prediction modes to first prediction processing unit 141 and second prediction processing unit 142.

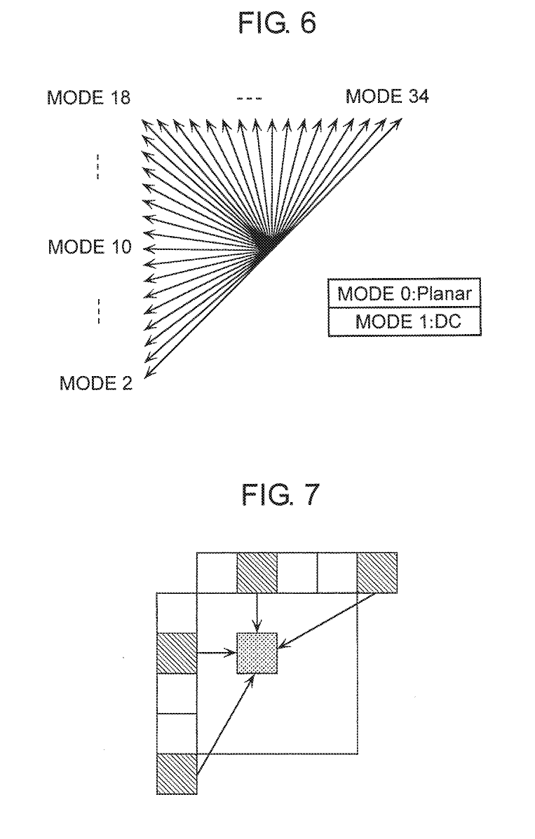

FIG. 6 is a diagram illustrating 35 intra prediction modes (mode 0 to mode 34) defined in the HEVC standard. As shown in FIG. 6, prediction modes defined in the HEVC standard are a planar prediction mode (mode 0), a DC prediction mode (mode 1), and 33 directional prediction modes (modes 2 to 34). Hereinafter, the intra prediction mode will also be referred to simply as the prediction mode. Also, prediction modes 0 to 34 correspond to modes 0 to 34 defined in the coding standard.

FIG. 7 is a diagram for explaining the planar prediction mode (mode 0). In the planar prediction mode, as shown in FIG. 7, a weighted average of four pixel data contained in each of upper, left, lower left and upper right blocks relative to an object block is calculated to obtain a predicted value of an object pixel.

In the DC prediction mode (mode 1), an average is obtained using all usable pixel data neighboring the top and left of the object block, and a filtering may be performed depending on the block size, to produce a predicted value. In each of the directional prediction modes, a predicted value is produced using pixel data located in the corresponding prediction direction among usable pixel data around the object block.

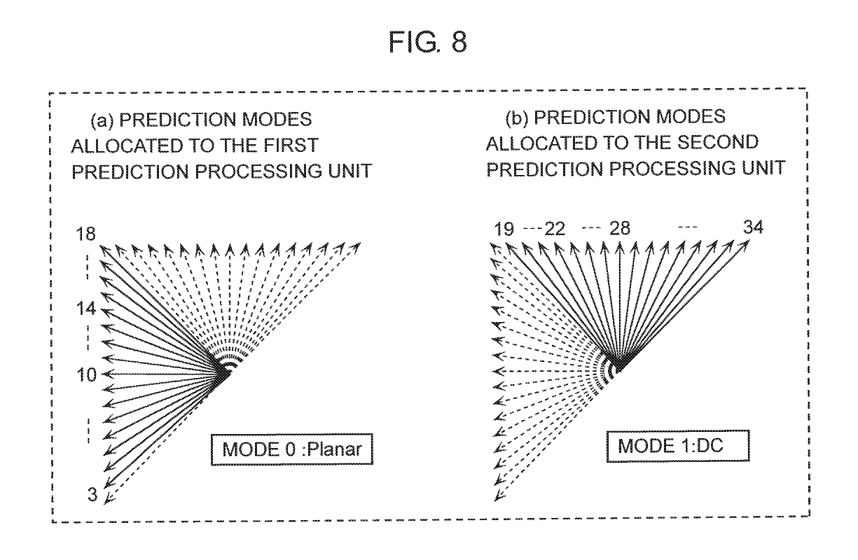

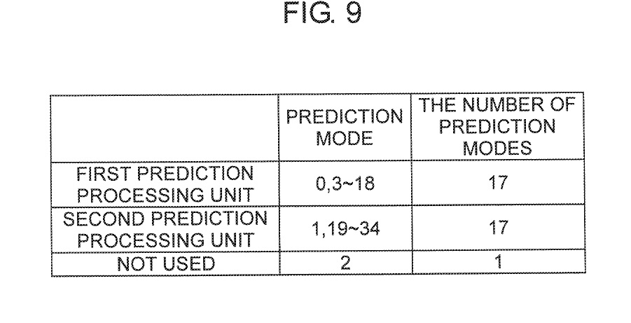

Each of FIG. 8 and FIG. 9 is a diagram illustrating an example of prediction modes allocated to first prediction processing unit 141 and second prediction processing unit 142. As shown in FIG. 8 and FIG. 9, prediction modes 0 and 3 to 18 are allocated to first prediction processing unit 141, and prediction modes 1 and 19 to 34 are allocated to second prediction processing unit 142. Also, prediction mode 2 is not used.

Like this manner, in the present exemplary embodiment, (1) m prediction modes are equally allocated to a plurality of prediction processing units (first prediction processing unit 141 and second prediction processing unit 142). In other words, the same number of prediction modes are allocated to each of a plurality of prediction processing units by limiting the use of a part of the available prediction modes such that the number in of the allocated prediction modes becomes an integer multiple of the number of the prediction processing units. Further, (2) the planar prediction mode (mode 0) and the DC prediction mode (mode 1) are respectively allocated to different prediction processing units. Further, (3) the same number of directional prediction modes are allocated to each of the plurality of prediction processing units.

Allocation of prediction modes in this manner makes it possible to reduce the difference in computational complexity (processing time) among the plurality of prediction processing units. Generally, in a case of performing a parallel processing, the total processing time depends on the processing of a prediction processing unit that has the largest computational complexity (the longest processing time). Therefore, the total processing time can be reduced by reducing the difference in the computational complexity (the processing time) among the plurality of prediction processing units.

Further, there is a case that the directional prediction mode is different in the computational complexity from the other prediction modes (the planar prediction mode and the DC prediction mode). Accordingly, the difference in the computational complexity can be further reduced by allocating the plurality of prediction modes to the plurality of prediction processing units such that the number of the directional prediction modes is the same and the number of the other prediction modes is the same in each of the plurality of prediction processing units according to the above allocation rules (2) and (3).

Further, as shown in FIG. 8, (4) the plurality of prediction modes are divided at mode 18 as a boundary (see upper left) into a group including mode 18 and modes of mode numbers smaller than 18 and a group including modes of mode numbers larger than 18, and the groups are respectively allocated to the two prediction processing units. In other words, the directional prediction modes are divided into a plurality of groups so that prediction modes of adjacent prediction directions belong to a same group, and the plurality of groups are respectively allocated to the plurality of prediction processing units. By the allocation in this manner, an arithmetic equation used in each prediction processing unit has a symmetric property, so that the circuit design of each prediction processing unit becomes easy. Specifically, a circuit of one prediction processing unit can be used for a circuit of another prediction processing unit. Accordingly, the design man-hours can be reduced, which in turn prevents occurrence of design mistakes, so that design verification can be easily performed.

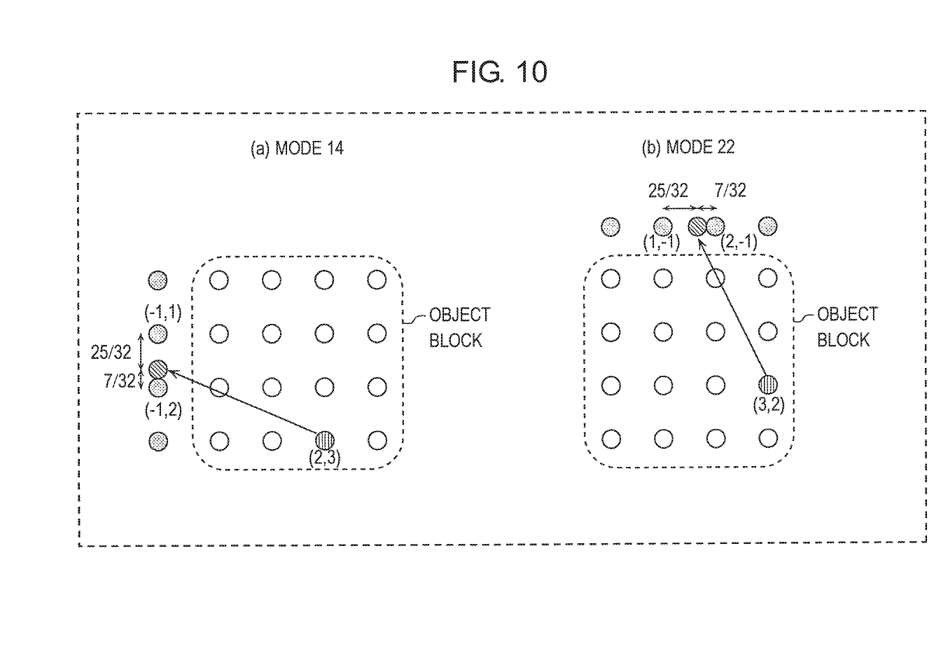

For example, FIG. 10 shows example cases of prediction performed with respect to an object block of 4×4 pixels, in which (a) shows a case that a prediction of mode 14 is performed, and (b) shows a case that a prediction of mode 22 is performed. In the prediction of mode 14, predicted value p[2][3] of the pixel at coordinates (2, 3) can be calculated using pixel value p[−1][1] at coordinates (−1, 1), pixel value p[−1][2] at coordinates (−1, 2), and formula (1) shown below.

p[2][3]=(7×p[−1][1]+25×p[−1][2]+16)/32 (1)

Also, in the prediction of mode 22, predicted value p[3][2] of the pixel at coordinates (3, 2) can be calculated using pixel value p[1][−1] at coordinates (1, −1), pixel value p[2][−1] at coordinates (2, −1), and formula (2) shown below.

p[3][2]=(7×p[1][−1]+25×p[2][−1]+16)/32 (2)

Like this, mode 14 and mode 22 are symmetrical to each other. Similarly, modes 2 to 17 are symmetrical to modes 34 to 19, respectively. Accordingly, it is possible to easily perform the circuit design of each prediction processing unit by allocating two prediction modes which are symmetrical to each other to different prediction processing units.

According to the present exemplary embodiment, as described above, the use of a part of the available prediction modes is restricted so that prediction modes can be equally allocated to the plurality of prediction processing units. This makes it possible to reduce variations in the computational complexity between the prediction processing units, so that the parallel processing can be efficiently performed.

On the other hand, it is concerned that prediction accuracy may be degraded. According to the present exemplary embodiment, an efficient parallel processing can be realized while suppressing degradation of prediction accuracy by setting the usage-restricted prediction mode in the following manner.

Specifically, in the present exemplary embodiment, as shown in FIG. 8 and FIG. 9, the use of mode 2 is restricted. The prediction direction of mode 2 is different by 180° from that of mode 34. Therefore, if mode 2 is effective for a certain image, mode 34 is also effective for the image in most cases. For example, in a case of a image in which there is a correlation of pixels in a direction from lower left to upper right, both mode 2 and mode 34 are effective for the image. Accordingly, degradation of prediction accuracy can be suppressed by selecting one of mode 2 and mode 34 as a prediction mode to be restricted.

Also, there is a case that the lower left block has not yet been encoded at the time the object block is encoded. In this case, pixel data of the lower left block is complemented using other pixel data (for example, pixel data of the left block). However, in many cases, prediction accuracy based on the complemented pixel data is not reliable. Therefore, the prediction mode referring to the pixel data of the lower left block tends to show larger cost value calculated in the evaluation processing, and thus is less possible to be selected. In other words, even if the use of the prediction mode referring to the pixel data of the lower left block is restricted, it is likely that the prediction mode to be selected will not change. Accordingly, degradation of the coding efficiency will be less even if the use of the prediction mode referring to the pixel data of the lower left block is restricted.

Although the case of performing a parallel processing by two prediction processing units has been described as an example in the above description, the number of prediction processing units performing a parallel processing may be three or more. In the case of using three or more prediction processing units, it is impossible to simultaneously satisfy both of the above conditions of (1) allocating m prediction modes equally to a plurality of prediction processing units and (2) allocating the same number of directional prediction modes to each of the plurality of prediction processing units. Accordingly, a plurality of prediction modes may be allocated to the plurality of prediction processing units so as to satisfy one of the conditions (1) and (2).

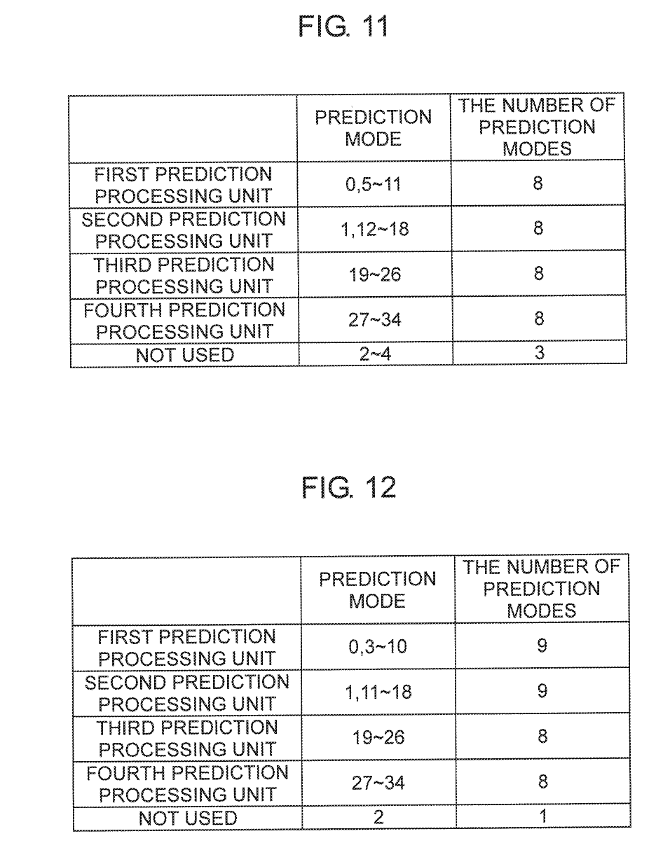

FIG. 11 is a diagram illustrating an example of allocating prediction modes to four prediction processing units. In the example shown in FIG. 11, the number of prediction modes allocated to each of the four prediction modes is the same. In addition, mode 0 and mode 1 are allocated to different prediction processing units, in the same way as the case described above. Also, in the example shown in FIG. 11, the use of three prediction modes (modes 2 to 4) sequentially from the directional prediction mode referring to the lower left direction is restricted. Like this manner, in a case of restricting the use of a plurality of prediction modes, the restricted prediction modes may be selected from the prediction modes referring to the lower left block of the object block. Also, the restricted prediction modes may be selected in the order from the prediction mode referring to the lower left direction (mode 2) toward a prediction mode referring to the upper left direction.

FIG. 12 is a diagram illustrating another example of allocating prediction modes to four prediction processing units. Although the same number of directional prediction modes are allocated to each of the plurality of prediction processing units in the example shown in FIG. 12, the number of prediction modes allocated to each prediction processing unit is different from the number of prediction modes allocated to another prediction processing unit.

When FIG. 11 and FIG. 12 are compared to each other, the prediction mode that is not used is only mode 2 in the case shown in FIG. 12, so that, in the case shown in FIG. 12, it is possible to reduce the number of prediction modes that are not used compared to the case shown in FIG. 11. Accordingly, degradation of prediction accuracy can be suppressed. On the other hand, since the number of prediction modes allocated to each prediction processing unit is different from another, variations in the computational complexity among the prediction processing units increase. However, if, for example, the computational complexity of mode 0 and mode 1 are smaller than those of the other modes, variations in the computational complexity can be changed.

As described above, in a case where the computational complexity of each prediction mode is different from that of another prediction mode, the number of prediction modes allocated to each prediction processing unit may not necessarily be the same. In other words, a plurality of prediction modes may be allocated to a plurality of prediction processing units based on the computational complexity of each prediction mode so that differences in the computational complexity among the plurality of prediction processing units become small.

Also, although a plurality of prediction modes are allocated to a plurality of prediction processing units so as to satisfy a plurality of conditions, it is not necessary to satisfy all of the conditions. For example, a plurality of prediction modes may be allocated to a plurality of prediction processing units so as to satisfy a part of a plurality of conditions.

### SUMMARY

As described hereinabove, intra prediction unit 109 (an intra prediction device) is a device for performing intra predictions compliant with a specified picture coding standard, and comprises n prediction processing units (first prediction processing unit 141 and second prediction processing unit 142) that perform a parallel processing of the intra predictions (n is an integer larger than one). Each of in prediction modes excluding at least one prediction mode among a plurality of prediction modes defined in the specified picture coding standard is allocated to one of the n prediction processing units (m is an integer larger than one). Each of the n prediction processing units performs an evaluation processing for the allocated one or more prediction modes to evaluate which prediction mode is to be selected among the m prediction modes.

With this configuration, even in a case where the plurality of prediction modes cannot be allocated to the n prediction processing units so that the computational complexity of the n prediction processing units become uniform, variations in the computational complexity among the prediction processing units can be reduced by restricting the uses of a part of the prediction modes.

For example, m may be an integer multiple of n, and the m prediction modes may be equally allocated to n prediction processing units.

This makes it possible to reduce variations in the computational complexity.

For example, the m prediction modes may include a prediction mode which uses an arithmetic equation that is symmetrical to an arithmetic equation of another prediction mode included in the m prediction modes, and the prediction modes using the arithmetic equations symmetrical to each other may be allocated to different prediction processing units.

This makes it possible to easily design the circuit of each prediction processing unit.

For example, the m prediction modes may include a DC prediction mode and a planar prediction mode, and the DC prediction mode and the planar prediction mode may be allocated to different prediction processing units.

This makes it possible to reduce variations in the computational complexity among the plurality of prediction processing units.

For example, a plurality of prediction modes may include two prediction modes which are different in prediction direction by 180° from each other, and the m prediction modes may include only one of the two prediction modes, without including the other of the two prediction modes.

This makes it possible to suppress degradation of the prediction accuracy which might otherwise be caused by restricting the use of a prediction mode. In other words, it is possible to reduce the computational complexity of the prediction processing units, while suppressing degradation of the prediction accuracy.

For example, at least one prediction mode excluded from the plurality of prediction modes may include a prediction mode which refers to a lower left block relative to an object block to be processed.

This makes it possible to suppress degradation in the prediction accuracy which might otherwise be caused by restricting the use of a prediction mode. In other words, it is possible to reduce the computational complexity of the prediction processing units, while suppressing degradation of the prediction accuracy.

Hereinafter, the prediction mode the use of which is restricted will be referred to as an excluded prediction mode. Degradation of prediction accuracy is small in a case where a prediction mode selected as an excluded prediction mode is such a prediction mode that is one of two prediction modes which are different in prediction direction by 180° from each other and refers to a lower left block relative to an object block to be processed. In other words, selection of this prediction mode as an excluded prediction mode makes it possible to reduce the computational complexity of the prediction processing unit while suppressing degradation of prediction accuracy. In a case of selecting two or more prediction modes as excluded prediction modes, the excluded prediction modes may include such a prediction mode that is one of two prediction modes which are different in prediction direction by 180° from each other and refers to a lower left block relative to an object block to be processed. Also, the other excluded prediction modes may be selected from such prediction modes that refer to a lower left block relative to an object block to be processed. Selection of excluded prediction modes in this manner makes it possible to reduce the computational complexity of the prediction processing unit while suppressing degradation of prediction accuracy.

It is expected that the technical idea according to the present disclosure would provide a certain effect in an intra prediction device, an intra prediction method and an intra prediction circuit each using a prediction processing unit which performs a sequential processing instead of the parallel processing. That is, it is possible to reduce the computational complexity of the prediction processing unit while suppressing degradation of prediction accuracy in an intra prediction device, an intra prediction method and an intra prediction circuit each using prediction processing units which perform a parallel processing, the technical idea according to the present disclosure makes it possible to reduce variations in the computational complexity among the prediction processing units, and thus is more effective to reduce the computational complexity of the prediction processing units.

Although an intra prediction compliant with the HEVC standard has been described in the present exemplary embodiment, a part or all of the technical idea according to the present disclosure may he effective in some other picture coding standards. For example, the technical idea according to the present disclosure may be applied to the H.264 scheme, a predecessor of the HEVC standard.

On the other hand, the technical idea according to the present disclosure is particularly useful for the intra prediction compliant with the HEVC standard. The computational complexity of intra prediction processing in the HEVC scheme is remarkably larger than that in the H.264 scheme. Therefore, it is more important in the HEVC system to disperse the computational complexity by configuring prediction processing units so as to perform a parallel processing, in addition to reduce the computational complexity. By configuring prediction processing units so as to perform a parallel processing, occurrence of variations in the computational complexity among the processing units will possibly arise as a new problem to be solved. The variations in the computational complexity can be reduced by the technical idea according to the present disclosure.

Further, the HEVC scheme is required to perform a more highly accurate intra prediction compared to the H.264 scheme. In other words, it is desirable for the intra prediction compliant with the HEVC standard to reduce the computational complexity while maintaining the accuracy of intra prediction as high as possible. The technical idea according to the present disclosure makes it possible to reduce the computational complexity while suppressing degradation of accuracy of intra prediction. Particularly, degradation of accuracy of intra prediction can be more effectively suppressed by selecting as the excluded prediction mode one of two prediction modes which are different in prediction direction by 180° from each other.

In the above description, an exemplary embodiment has been described as an example of techniques according to the present disclosure. For the purpose of the description, the accompanying drawings and the detailed description have been provided.

Accordingly, the components shown in the drawings and described in the detailed description may include not only components that are essential to solve the problems, but also components that are for exemplifying the above-described techniques and thus are not essential to solve the problems. Therefore, it should not immediately recognize that such non-essential components are essential merely for the reason that they are shown in the drawings or described in the detailed description.

Also, since the above-described exemplary embodiment is for exemplifying the techniques according to the present disclosure, various modifications, substitutions, additions or omissions may be made within the scope of the claims and equivalents thereof.

These general or specific aspects may be implemented by a device, a system, a method, an integrated circuit, a computer program or a computer-readable storage medium such, for example, as a CD-ROM, or may be implemented as any combination of a system, a method, an integrated circuit, a computer program and a storage medium.

Further, in the above exemplary embodiment, each component may be configured by a dedicated hardware or may be realized by executing a software program appropriate for each component. Each component may be realized by a program executing unit such, for example, as a CPU (Central Processing Unit) or a processor, which reads out a software program stored in a storage medium such, for example, as a hard disk or a semiconductor memory and executes the software program.

Further, all of the numbers used in the above description are exemplified numbers for specifically explaining the present disclosure. Accordingly, the present disclosure should not be limited to the exemplified numbers.

Further, the functional blocks divided in the block diagrams are merely examples. A plurality of functional blocks may be realized as a single functional block, a single block may be divided into a plurality of functional blocks, or a part of functions in a functional block may be moved to another functional block. Also, similar functions in a plurality of functional blocks may be performed in parallel or in a time-divisional manner by a single hardware or a single software.

Further, the order of the steps shown in the above flowchart is an exemplifying order merely for specifically explaining the present disclosure, and may be changed to other orders than the above. Also, a part of the above steps may be executed simultaneously parallel) with another step.

The present disclosure is applicable to intra prediction devices and picture coding devices. Specifically, the present disclosure is applicable to recorders, digital cameras or tablet terminals.

What is claimed is:

1. An intra prediction device for performing intra predictions compliant with a specified picture coding standard, the intra prediction device comprising n prediction processing units that perform a parallel processing of the intra predictions, where n is an integer larger than one,
wherein each of in prediction modes excluding at least one prediction mode among a plurality of prediction modes defined in the specified picture coding standard is allocated to one of the n prediction processing units, where m is an integer larger than one, and
wherein each of the n prediction processing units performs an evaluation processing for allocated one or more prediction modes to evaluate which prediction mode is to he selected among the in prediction modes.

2. The intra prediction device according to claim 1, wherein m is an integer multiple of n, and the m prediction modes are equally allocated to the n prediction processing units.

3. The intra prediction device according to claim 1, wherein the in prediction modes include a prediction mode which uses an arithmetic equation that is symmetrical to an arithmetic equation of another prediction mode, and the prediction modes using the arithmetic equations symmetrical to each other are allocated to different prediction processing units.

4. The intra prediction device according to claim 1, wherein the m prediction modes include a DC prediction mode and a planar prediction mode, and the DC prediction mode and the planar prediction mode are allocated to different prediction processing units.

5. The intra prediction device according to claim 1, wherein the plurality of prediction modes include two prediction modes which are different in prediction direction by 180° from each other, and the m prediction modes include only one of the two prediction modes without including the other of the two prediction modes.

6. The intra prediction device according to claim 5, wherein the at least one prediction mode excluded from the plurality of prediction modes includes a prediction mode which refers to a lower left block relative to an object block to be processed.

7. The intra prediction device according to claim 1, wherein the at least one prediction mode excluded from the plurality of prediction modes includes a prediction mode which refers to a lower left block relative to an object block to be processed.

8. An intra prediction device for performing intra predictions compliant with a specified picture coding standard,
wherein the intra prediction device excludes as an excluded prediction mode at least one prediction mode among a plurality of prediction modes defined in the specified picture coding standard, and
wherein the intra prediction device performs the infra predictions in such prediction modes of the plurality of prediction modes that are not included in the excluded prediction mode.

9. The intra prediction device according to claim 8, wherein the plurality of prediction modes include two prediction modes which are different in prediction direction by 180° from each other, and the excluded prediction mode includes only one of the two prediction modes without including the other of the two prediction modes.

10. The intra prediction device according to claim 9, wherein the excluded prediction mode includes a prediction mode which refers to a lower left block relative to an object block to be processed.

11. The intra prediction device according to claim 8, wherein the excluded prediction mode includes a prediction mode which refers to a lower left block relative to an object block to be processed.

12. An intra prediction method for performing intra predictions compliant, with a specified picture coding standard, the intra prediction method comprising a parallel processing step for performing a parallel processing of the intra predictions by n prediction processing units, where n is an integer larger than one,
wherein each of m prediction modes excluding at least one prediction mode among a plurality of prediction modes defined in the specified picture coding standard is allocated to one of the n prediction processing units, where m is an integer larger than one, and
wherein, in the parallel processing step, each of the n prediction processing units performs an evaluation processing for allocated one or more prediction modes to evaluate which prediction mode is to be selected among the m prediction modes.

13. An intra prediction method for performing intra predictions compliant with a specified picture coding standard,
wherein the intra prediction method excludes as an excluded prediction mode at least one prediction mode among a plurality of prediction modes defined in the specified picture coding standard,
wherein the excluded prediction mode includes only one of a pair of prediction modes which are different in prediction direction by 180° from each other, and
wherein the intra prediction method performs the intra predictions in such prediction modes of the plurality of prediction modes that do not include the excluded prediction mode.
